(19) United States
(12) Patent Application Publication
(10) Pub. No.: US 2009/0296256 A1
(43) Pub. Date: Dec. 3, 2009

(54) THERMAL-ASSIST MAGNETIC RECORDING DEVICE AND THERMAL-ASSIST MAGNETIC STORAGE DEVICE

(75) Inventor: Isao Tsuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/408,689

(22) Filed: Mar. 21, 2009

(30) Foreign Application Priority Data
May 29, 2008 (JP) 2008-140371

(51) Int. Cl. G11B 5/02

(52) U.S. Cl. 360/59; G9B/5.026

(57) ABSTRACT

A thermal-assist magnetic recording device performs a thermal-assist magnetic recording to achieve high density recording compatible with high speed transfer at low cost. The thermal-assist magnetic recording device includes a signal selector circuit that selects a read signal from the read element at the time of reading by the read element, selects a write signal to the write element at the time of writing by the write element and drives the light transmission unit by the selected signal, and an output light selection unit that outputs an output light from the light transmission unit, as either an optical signal at the time of reading or a thermal assist light for applying the heat at the time of writing.

### CROSS-REFERENCE TO RELATED APPLICATIONS

This application is based upon and claims the benefit of priority of the prior Japanese Patent Application No. 2008-140371, filed on May 29, 2008, the entire contents of which are incorporated herein by reference.

### FIELD

The present invention relates to a thermal-assist magnetic recording device and a thermal-assist magnetic storage device which performs magnetic recording by supplying a magnetic field while applying heat, and more particularly the thermal-assist magnetic recording device and a thermal-assist magnetic storage device which achieves high recording density compatible with high speed transfer in the magnetic recording device.

### BACKGROUND

A recording density of a magnetic recording medium, particularly a magnetic disk, continues to increase by technology of stable magnetism of a medium, increased sensitivity of a read head and a decreased distance between the medium and the head (low floating). In such a trend, in the case that the surface recording density is achieved to have 10 [Terabits/inch²], it is necessary to reduce the mark size thereof (bit length) to be as small as 8 nm or less, under the aspect ratio of 1:1.

Generally, when the surface recording density is increased, thermal fluctuation tolerance is reduced due to minute particles of a magnetic domain. Because this causes unstable magnetism, it is difficult to maintain long-term retention of the recorded magnetism. To improve the thermal stability, it is necessary to increase coercive force. For this purpose, it is necessary to strengthen the magnetic field to be applied. However, to increase the recording density, it is necessary to narrow a core width of a write element in a head. By this, the applied magnetic field is decreased, and writing becomes difficult. In short, when aiming to improve surface recording density, there is a contradictory relationship between increasing the coercive force and strengthening the write magnetic field.

A thermal assist recording method has been proposed as a technique to solve the above-mentioned problem (refer to Patent document 1 and Patent document 2, for example). The above technique is a technique which performs magnetic recording by heating a magnetic recording medium using a heat source, such as a laser, at the time of magnetic recording, so as to decrease the coercive force. Namely, when temperature of a recording film reaches the Curie point by heating, the material is shifted from ferromagnetism to paramagnetism, thereby becoming susceptible to an external magnetic field. As a result, writing becomes easy.

Meanwhile, when considering the relationship between the recording density and a data transfer speed, for example, assuming a case that a disk medium having a diameter of 3.5 inch (=88.9 mm) is rotated at 15,000 [rpm] (=250 revolutions/sec), a linear speed in the vicinity of the outer circumference of the disk medium becomes 69.8 m/sec. In the aforementioned case of the bit length of 8 nm at the recording density of 10 [Terabits/inch²], the transfer speed becomes as high as 8.7 [Gigabits/sec].

Assuming that the linear speed is constant, a required transfer speed increases substantially in proportion to a square root of the increase of the surface recording density. As such, both increased recording density and a shortened access time inevitably accompany a higher transfer speed. Using the conventional electric transmission technology, it is predicted that gradually the implementation will become difficult. As a technique to solve the above problem, the utilization of an optical communication technology has been proposed.

[Patent document 1] the official gazette of the Japanese Unexamined Patent Publication No. Hei-6-243527.

[Patent document 2] the official gazette of the Japanese Unexamined Patent Publication No. 2003-157502.

In the prior art, there have been independent studies of the thermal assist recording and the application of the optical communication to improve the transfer speed. However, when the surface recording density is improved by use of the thermal assist recording, there is a problem that, without an improved data transfer speed, read/write performance making full use of the high surface recording density is not obtainable.

### SUMMARY

Accordingly, it is an object of the present invention to provide a thermal-assist magnetic recording device and a thermal-assist magnetic storage device to achieve high density recording compatible with high speed transfer, using a light source for the thermal-assist recording also for optical communication of a read data.

Also, it is another object of the present invention to provide a thermal-assist magnetic recording device and a thermal-assist magnetic storage device to achieve high density recording compatible with high speed transfer at low cost, by performing high speed transfer using a light source for thermal-assist recording.

It is still another object of the present invention to provide a thermal-assist magnetic recording device and a thermal-assist magnetic storage device to perform suitable control for thermal assist performance and light transfer performance at the time of reading, even when a light source for thermal-assist recording is commonly used for light transmission.

To achieve the above-described objects, a thermal-assist magnetic recording device for reading data from a magnetic recording medium and writing data while applying heat, includes: a read element which reads the data from the magnetic recording medium; a write element which writes data on the magnetic recording medium; a light transmission unit; a signal selector circuit which selects a read signal from the read element at the time of reading by the read element, selects a write signal to the write element at the time of writing by the write element, and drives the light transmission unit by the selected signal; and an output light selection unit which outputs an output light from the light transmission unit, as either an optical signal at the time of reading or a thermal assist light for applying the heat at the time of writing.

Also to achieve the above-described objects, a thermal-assist magnetic storage device includes: a magnetic recording medium; a read element which reads the data from the magnetic recording medium; a write element which writes data on the magnetic recording medium; a light transmission unit; a signal selector circuit which selects a read signal from the read element at the time of reading by the read element, selects a write signal to the write element at the time of writing by the write element, and drives the light transmission unit by the selected signal; and an output light selection unit which outputs an output light from the light transmission unit, as either an optical signal at the time of reading or a thermal assist light for applying the heat at the time of writing.

Also in the present invention, it is preferable that the thermal-assist magnetic recording device further includes: a light signal control unit which controls a light output characteristic of the light transmission unit to be different light output characteristics at the time of reading from the light output characteristics at the time of writing.

Also in the present invention, it is preferable that the thermal-assist magnetic recording device further includes: a slider which is mounted the read element and the write element mounted thereon; and a fixed section which has the light transmission unit, the signal selector circuit and the output light selection unit.

Also in the present invention, it is preferable that the thermal-assist magnetic recording unit further includes: a slider which is mounted at least the read element, the write element, the light transmission unit and the output light selection unit.

Also in the present invention, it is preferable that the output light selection unit is constituted of a light switch which switches output destinations according to a read instruction and a write instruction.

Also in the present invention, it is preferable that the light transmission unit further includes: an electro-optical conversion element and a drive circuit which drives the electro-optical conversion element.

Also in the present invention, it is preferable that the light signal control unit further includes: a monitor element which monitors the output light from the light transmission unit; and a control circuit which compares an output value of the monitor element with either a control target value at the time of reading or a control target value at the time of writing, and controls light output power of the light transmission unit according to the comparison result.

Also in the present invention, it is preferable that the light transmission unit further includes an electro-optical conversion element and a drive circuit which drives the electro-optical conversion element, and the control circuit controls electric current value of the drive circuit.

Also in the present invention, it is preferable that the control circuit further includes: an average value detector circuit which detects an average value of the monitor element output, a peak value detector circuit which detects a peak value of the monitor element output; a comparison circuit which compares an output value of the average value detector circuit with the control target value at the time of reading, while at the time of writing, comparing an output value of the peak value detector circuit with the control target value at the time of writing; and a current control circuit which controls a current value of the drive circuit by the comparison circuit output.

Also in the present invention, it is preferable that the drive circuit further includes: a bias current source which supplies a bias current to the electro-optical conversion element; and a drive current circuit which flows a drive current to the electro-optical conversion element according to the read signal or the write signal, wherein the control circuit controls the current value of the bias current source and the current value of the drive current circuit according to a ratio of each bias current value and the drive current value, instructed at the time of reading and at the time of writing.

Also in the present invention, it is preferable that the control circuit further includes: a read current set circuit which controls the current value of the bias current source and the current value of the drive current circuit, according to the ratio of the bias current value and the drive current value, instructed at the time of reading; and a write current set circuit which controls the current value of the bias current source and the current value of the drive current circuit according to the ratio of the bias current value and the drive current value, instructed at the time of writing.

Also in the present invention, it is preferable that the control circuit further includes: a resistor which is set the drive current value; a first digital/analog converter circuit which digital-to-analog converts the drive current value in the register and outputs a control current of the drive current circuit; and a second digital/analog converter circuit which digital-to-analog converts an inverted value of the drive current value in the register and outputs a control current of the bias current source.

Because the light source for thermal-assist recording is also used as the light source for read light transmission at the time of reading, high density recording compatible with high speed transfer can be achieved at low cost in a small size. Also, because of separate driving between at the time of reading and at the time of writing, the characteristic for the thermal assist light and for the optical communication light can be set optimally.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an outer view of one embodiment of the magnetic storage device according to the present invention;

FIG. 2 is an explanation diagram of a thermal-assist magnetic recording device in FIG. 1;

FIG. 3 is a block diagram of a unit commonly use for reading and writing in FIG. 2.

FIG. 4 is a configuration diagram of the read/write common unit according to a first embodiment of the present invention;

FIG. 5 is a configuration diagram of the read/write common unit according to a second embodiment of the present invention;

FIG. 6 is a configuration diagram of the read/write common unit according to a third embodiment of the present invention;

FIG. 7 is a configuration diagram of the read/write common unit according to a fourth embodiment of the present invention;

FIG. 8 is a mounting diagram of the read/write common unit according to a first embodiment of the present invention;

FIG. 9 is a mounting diagram of the read/write common unit according to a second embodiment of the present invention;

FIG. 10 is a mounting diagram of the read/write common unit according to a third embodiment of the present invention;

FIG. 11 is a configuration diagram of the transmission light control circuit according to one embodiment of the present invention;

FIG. 12 is an explanation diagram of LD modulation operation for a thermal assist light at the time of writing, in FIG. 11;

FIG. 13 is an explanation diagram of the LD modulation operation of a read signal at the time of reading, in FIG. 11;

FIG. 14 is a block diagram of LD control circuit shown in FIG. 11 according to one embodiment of the present invention;

FIG. 15 is a circuit diagram of a laser current set circuit shown in FIG. 14;

FIG. 16 is an exemplary configuration of a bias current and a ratio of a drive current of the first laser diode in FIG. 15;

FIG. 17 is an exemplary configuration of a bias current and a ratio of a drive current of the second laser diode in FIG. 15;

FIG. 18 is an exemplary configuration of a bias current and a ratio of a drive current of the third laser diode in FIG. 15;

FIG. 19 is a logic circuit diagram of the LD operation mode selector circuit in FIG. 14; and

FIG. 20 is an explanation diagram of an input signal and the operation mode thereof.

### DESCRIPTION OF EMBODIMENTS

The preferred embodiment of the present invention is described hereinafter, in the order of the configuration of a magnetic storage device, the configuration of a read/write common unit, the mounting of the read/write common unit, the detailed configuration of an LD control circuit of the read/write common unit, and other embodiments. However, the present invention is not limited to the embodiments described below.

[Magnetic Storage Device]

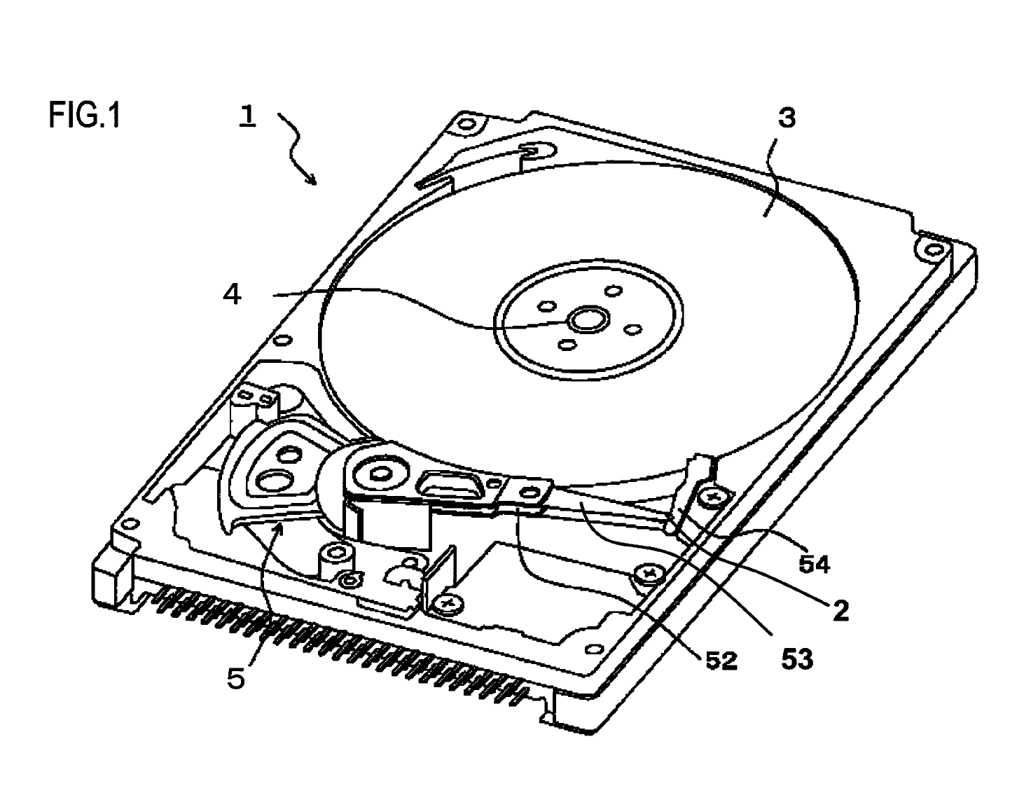

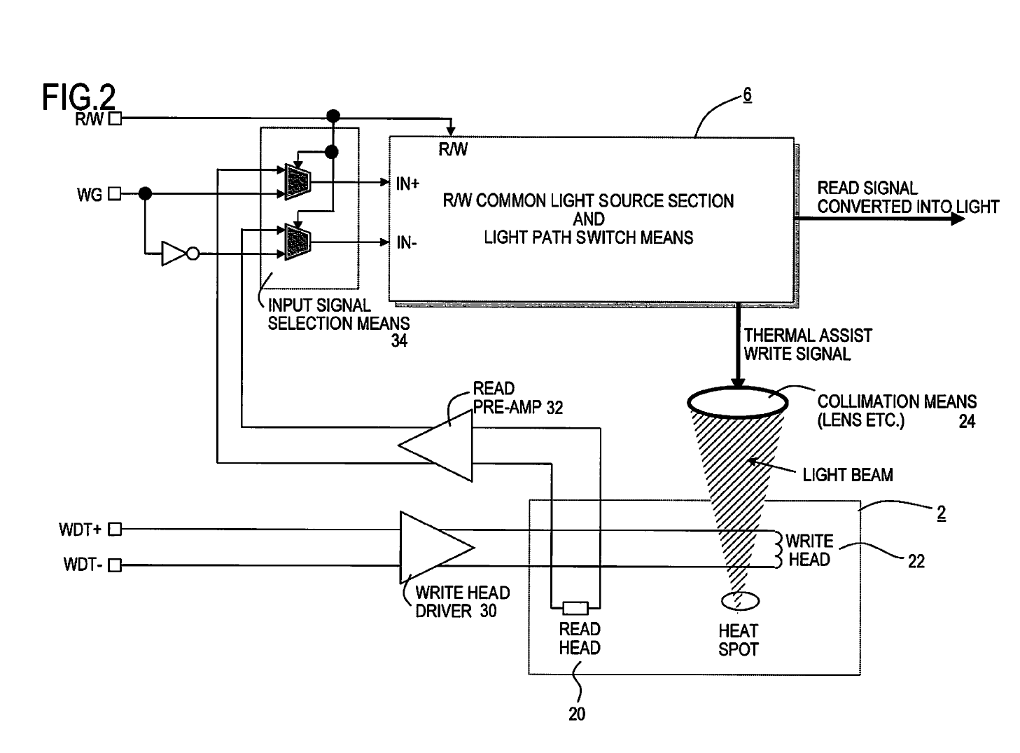

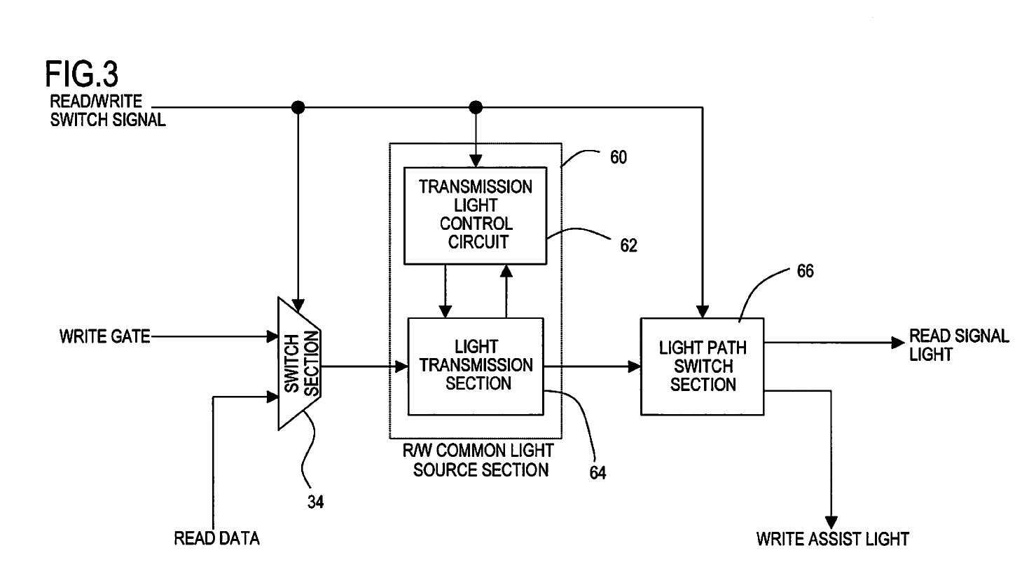

FIG. 1 is an outer view of one embodiment of the magnetic storage device according to the present invention. FIG. 2 is an explanation diagram of a read/write mechanism of the magnetic storage device in FIG. 1. FIG. 3 is a block diagram of a read/write common unit in FIG. 2. In FIG. 1 and FIG. 2, a magnetic disk device is exemplified as a magnetic storage device.

As indicated by FIG. 1, the magnetic disk device includes a drive mechanism (disk enclosure) 1 and a print circuit assembly (PCA) which is not illustrated. In the disk enclosure (DE) 1, a magnetic disk 3, which is a magnetic recording medium, is disposed on a rotating axis of a spindle motor 4. The spindle motor 4 rotates the magnetic disk 3.

An actuator (referred to as VCM) 5 rotates an arm 52. A suspension 53 is mounted on the arm 52, and on the top end of the suspension 53, a slider 2 including a magnetic head is provided.

The actuator 5 is configured of a voice coil motor (VCM) that rotates around the rotating axis, and moves and positions the slider 2 being provided on the top end of the suspension 53 to an arbitrary position (track) in the radial direction of the magnetic disk 3. In FIG. 1, one piece of the magnetic disk 3 is mounted on the magnetic disk device, and two sliders 2 are simultaneously driven by an identical actuator 5.

On the outer side of the magnetic disk 3, there is provided a ramp mechanism 54 for retracting the slider (magnetic head) 2 from the magnetic disk 3 and for parking.

As indicted by FIG. 2, the slider 2 has a read element 20 and a write element 22 respectively mounted thereon. For example, the slider 2 is configured of a read element 20, including a magnetic resistance (MR) element laminated, on the slider, and a write element 22 including a write coil laminated on the read element 20. Further, a collimator lens 24 for collimating the thermal assist light on a magnetic disk surface is mounted on the slider 2 in either an integrated or separate manner.

Both a write head drive circuit 30 for driving the write element 22 and a read preamplifier 32 for amplifying the output of the read element 20 are provided outside the slider 2. An input signal selector circuit 34 selects a write gate signal or a read signal from the preamplifier 32 by R/W signal instructing to read or write and outputs to a read/write common unit 6 commonly used for reading and writing.

As indicated by FIG. 3, the R/W common unit 6 includes a R/W common light source section 60, including a light transmission section 64 for transmitting after converting an electric signal into light and a transmission light control circuit 62 for controlling the output light power of the light transmission section. The R/W common light source unit 6 further includes the switch circuit (input signal selector circuit) 34 for selecting and switching an input signal to the light transmission section 64, and a light path switch section 66 for selecting and switching a path of an output light signal fed from the light transmission section 64.

For the light transmission section 64, a semiconductor laser device is appropriate. As a heat source for thermal assist recording, the use of the semiconductor laser device is generally considered. Also, in the optical communication technology, a high oscillation frequency and a coherent characteristic as a carrier provided by semiconductor laser light realize ultra-high-speed light intensity modulation.

In other words, in both thermal-assist recording technology to realize high recording density and optical transmission technology to cope with a high speed read signal accompanying high recording density, the semiconductor laser device is a common key device. However, although using the same semiconductor laser device, a light output characteristic required for thermal assist at the time of writing and a light output characteristic at the time of reading are not the same. On the other hand, from the viewpoint of resource and cost, it is not efficient to prepare laser devices dedicated for each use.

In the present invention, the thermal assist technology for high recording density is functionally combined with the optical communication technology for high speed transfer, accompanying the high recording density, to overcome the limit of electric transmission technology. Namely, one laser device (light source) is used as a heat source for thermal assist recording at the time of writing, and is additional commonly used as a signal light source for read light transmission at the time of reading. Further, according to the present invention, optimal control is performed to different laser drive characteristics required when performing the thermal assist at the time of writing and when performing the optical transmission at the time of reading.

As an input signal to the light transmission section 64, there are a write signal (write gate WG) to the magnetic disk 3 and a read signal (read data) from the magnetic disk 3. Also, as output light signals corresponding to the respective input signals, there are a write assist light for thermal assist recording at the time of writing and a read signal light converted from a read data at the time of reading.

At the time of writing on magnetic disk 3, the write assist light raises the temperature of a recording film of the medium 3 to the Curie point, so as to facilitate magnetic writing to the write element 22. In the write assist light, a light pulse is irradiated to a magnetization reversal point, in synchronization with a write pulse. A read signal light is a light linearly converted into an optical signal from a read signal, and enables data transmission at higher speed than an electric signal.

As such, the write assist light is a digital signal, while the read signal light is an analog signal. Therefore, each control target value is not always the same. For the reason, the transmission light control circuit 62 is configured to be able to cope with the write assist light and the read signal light, respectively.

The light path switch section 66 switches a light path to a read signal output and a write assist output according to a read/write switch signal (R/W signal). Also, the transmission light control circuit 62 switches a control target, and controls the light transmission section 64 to obtain optimal light output power at the time of reading and at the time of writing, respectively.

The combination of the light transmission section 64 with the transmission light control circuit 62 indicated by FIG. 3 configures the read/write common light source section 60 in a magnetic disk interface. To the sign “IN+/IN−” in FIG. 2, a signal selected from either a read signal, which is read by the read element (magnetic head for reading) 20 and amplified by the read preamplifier 32, or a WG (write gate signal at the time of writing) is input.

Also, in FIG. 2, the sign “R/W” is a control signal input for selecting either a read operation state or a write operation state. At the time of a read operation, a read signal after converted into light is output from the light transmission section 64. At the time of a write operation, a light for thermal assist is output therefrom.

In the following, the configuration of the read/write common unit (the R/W common light source section and the light path switch section) will be described.

[Configuration of the Read/Write Common Unit]

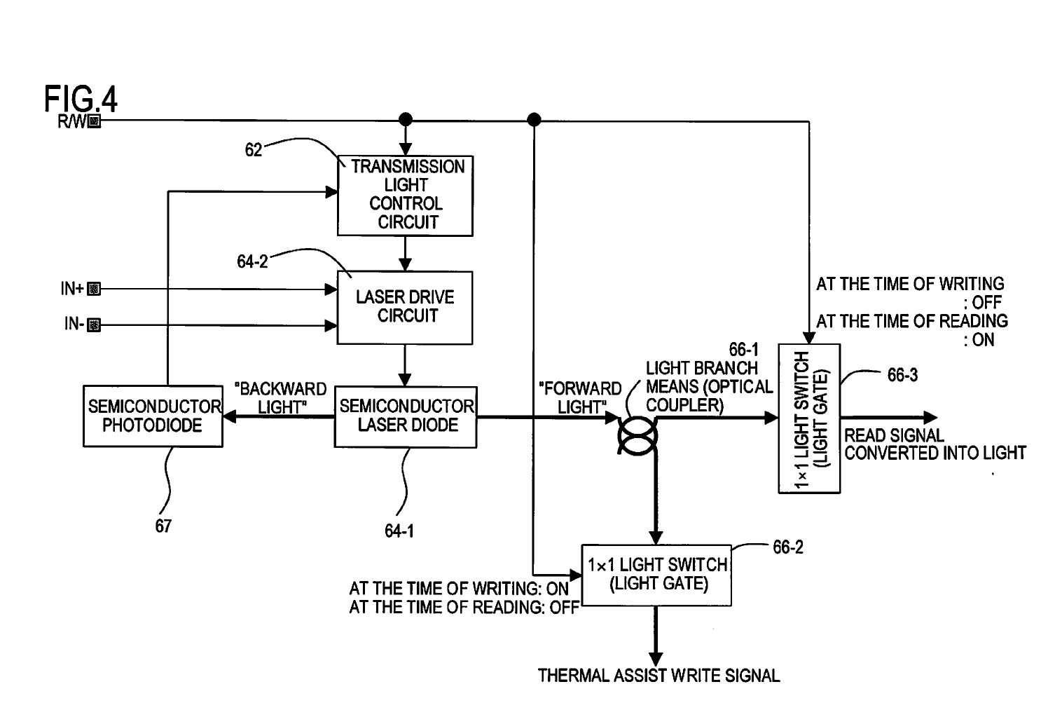

FIG. 4 is a configuration diagram of the read/write common unit according to a first embodiment of the present invention. In FIG. 4, the same parts as shown in FIGS. 2, 3 are indicated by the same symbols.

In FIG. 4, the light transmission section 64 includes a semiconductor laser diode (light source) 64-1 and a laser drive circuit (driver) 64-2 for driving the semiconductor laser diode 64-1 according to the input signal IN+/IN−. As shown in the figure, the semiconductor laser diode 64-1 outputs lights to the forward direction and the backward direction. In the example shown in FIG. 4, the forward output light is used as a signal light, while the backward output light is used as a light monitor signal for control.

A semiconductor photodiode (light monitor element) 67 receives the backward light of the semiconductor laser diode 64-1, converts the received light into an electric signal, and outputs the electric signal to the transmission light control circuit 62. According to the read/write control signal (R/W), the transmission light control circuit 62 indicates, to the laser drive circuit 64-2, a drive current value at the time of reading or a drive current value at the time of writing. Also, the transmission light control circuit 62 receives the monitor signal from the light monitor element 67, and controls the drive current value.

A light branch section 66-1 includes an optical coupler or a partial transmission mirror for separating an incident light into a transmission light and a reflection light. The light branch section 66-1 branches the forward light (transmission light) from the semiconductor laser diode 64-1 to a pair of light path switch sections 66-2 and 66-3. One light path switch section 66-2 is provided for outputting a write light for thermal assist, and outputs a thermal assist light to the magnetic recording medium through an optical system (optical fiber and optical waveguide). Also the other light path switch section 66-3 is provided for outputting a read transfer light signal, and externally outputs a read light signal through an optical communication path (optical fiber and optical waveguide).

According to the present embodiment, there is shown an example of using a 1×1 light switch as each light path switch section 66-2, 66-3. The 1×1 light switch is so-called a light gate element that simply performs ON/OFF operation.

The light switch of the above type is constituted of (1) a type of performing ON/OFF operation by the gain of an optical amplifier (for example, a semiconductor optical amplifier: SOA), (2) a type of mechanically intercepting light (for example, micro-electro mechanical systems: MEMS), (3) a type of utilizing optical phase modulation (for example, a Mach-Zehnder interferometer structure) or the like.

In response to a read/write instruction and an input signal, an output light being output from the semiconductor laser diode 64-1 is branched into two lights at the light branch section 66-1. Each light is incident to the pair of 1×1 light switches 66-2, 66-3. One light switch 66-2 is controlled ON at the time of writing, and OFF at the time of reading. The other light switch 66-3 is controlled OFF at the time of writing, and ON at the time of reading. Accordingly, at the time of writing, a write light for thermal assist is output from the one light switch 66-2, while at the time of reading, a read transfer light signal is output from the other light switch 66-3.

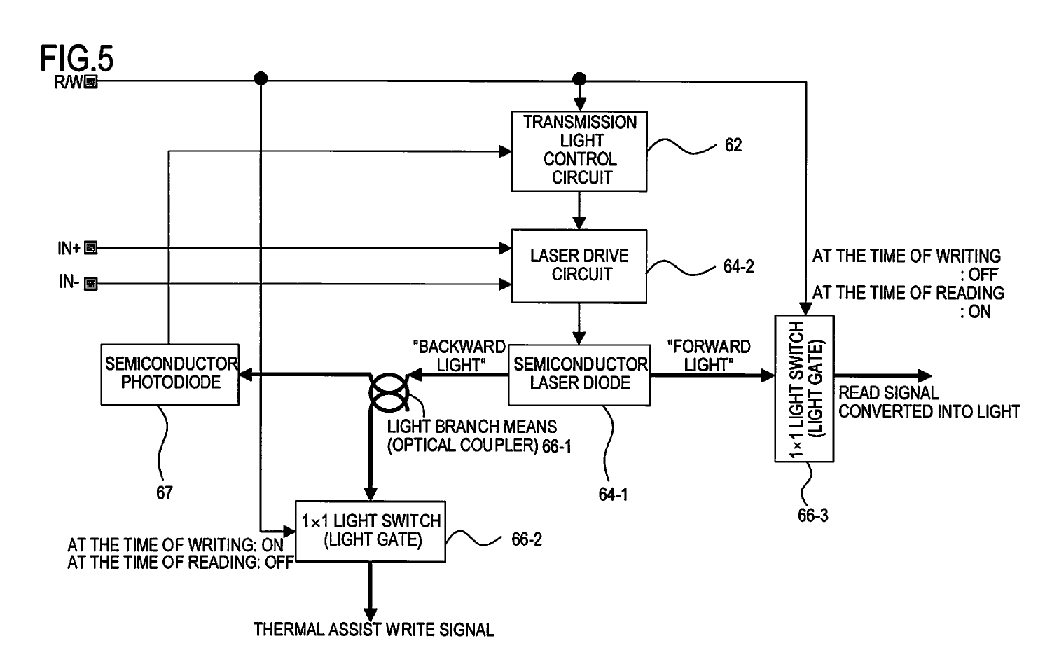

FIG. 5 is a configuration diagram of the read/write common unit according to a second embodiment of the present invention. In FIG. 5, the same parts as shown in FIG. 4 are shown by the same symbols.

In FIG. 5, the forward light from the semiconductor laser diode 64-1 is used for a read signal converted into light, in contrast to the use of the backward light for a thermal assist write light. More specifically, the light branch section 66-1 is disposed at a position where the backward light from the semiconductor laser diode 64-1 is branched to the photodiode 67 and the one light switch 66-2.

The backward light output from the semiconductor laser diode 64-1 is branched into two lights by the light branch section 66-1. Each light is incident to the photodiode 67 or 1×1 light switch 66-2. The one light switch 66-2 is controlled ON at the time of writing, and controlled OFF at the time of reading. The other light switch 66-3 is controlled OFF at the time of writing, and controlled ON at the time of reading. Accordingly, at the time of writing, a thermal assist write light is output from the one light switch 66-2, while at the time of reading, a read transfer light signal is output from the other light switch 66-3.

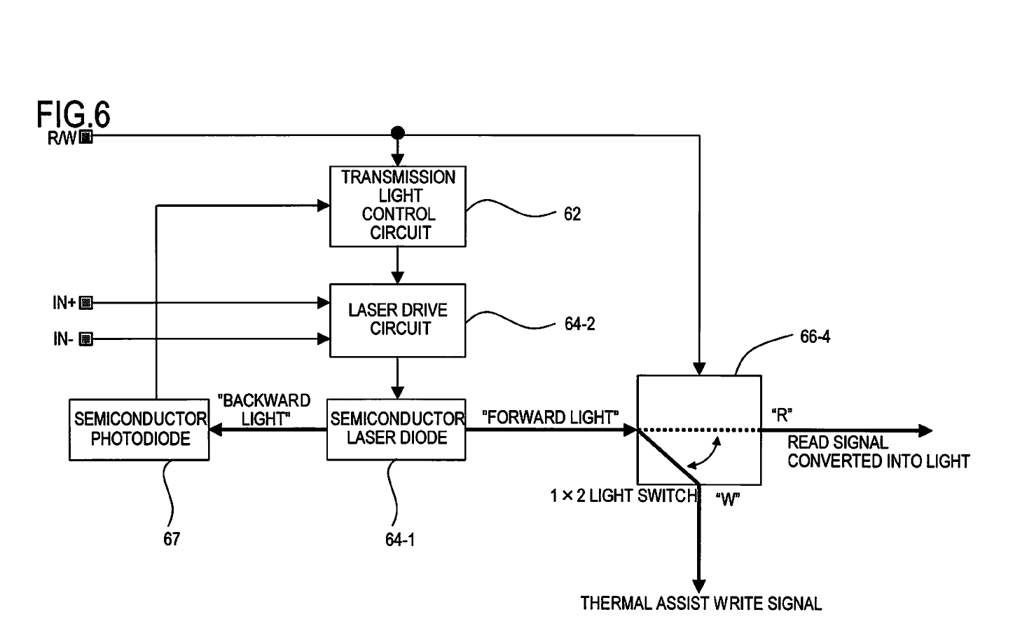

FIG. 6 is a configuration diagram of the read/write common unit according to a third embodiment of the present invention. In FIG. 6, the same parts as shown in FIGS. 4, 5 are shown by the same symbols.

The embodiment shown in FIG. 6 is an example in which a 1×2 light switch 66-4 is used as the light path switch section. The 1×2 light switch 66-4 switches an input optical signal to the outputs of mutually different ports by an external control signal. As a direct light path switch unit, 1×2 light switch 66-4 is most popularly used. The 1×2 light switch 66-4 has a variety of configurations such as a 1×N switch and an N×N matrix switch.

In response to a read/write instruction and an input signal, an output light (forward light) being output from the semiconductor laser diode 64-1 is incident to the light switch 66-4 which is controlled by a read/write control signal. At the time of writing, the light switch 66-4 is switched to the thermal assist side, so that a thermal assist write light is output, while at the time of reading, the light switch 66-4 is switched to the read transfer side, so that a read transfer light signal is output.

FIG. 7 is a configuration diagram of the read/write common unit according to a fourth embodiment of the present invention. In FIG. 7, the same parts as shown in FIGS. 4, 5 and 6 are shown by the same symbols.

The embodiment shown in FIG. 7 is an embodiment of using a 1×2 optical branching filter 66-5 as the light path switch section. As a typical optical branching filter 66-5, an array waveguide grating filter can be listed. The above optical branching filter 66-5 has a function of switching the output according to a light wavelength. By changing an oscillating wavelength of the semiconductor laser diode 64-1 between at the time of reading and at the time of writing, light is output from an output port corresponding to each wavelength of optical branching filter 66-5.

To switch the oscillating wavelength of the semiconductor laser diode 64-1, the dependency of the oscillating wavelength on temperature is utilized. Namely, a temperature control circuit 68 is provided on the semiconductor laser diode 64-1. The temperature control circuit 68 changes the temperature of the semiconductor laser diode 64-1 by switching the temperature between at the time of reading and at the time of writing. By this, wavelength conversion is performed.

For example, with the provision of a heater, the temperatures of the semiconductor laser diode 64-1 are changed between at the time of reading and at the time of writing.

Further, to set the paths for the read signal light and for the thermal assist light for writing, optical fibers are used. In addition thereto, by using a bend of optical waveguide 66-7, it is possible to output light to an arbitrary direction corresponding to a mounting form.

[Mounting of the Read/Write Common Unit]

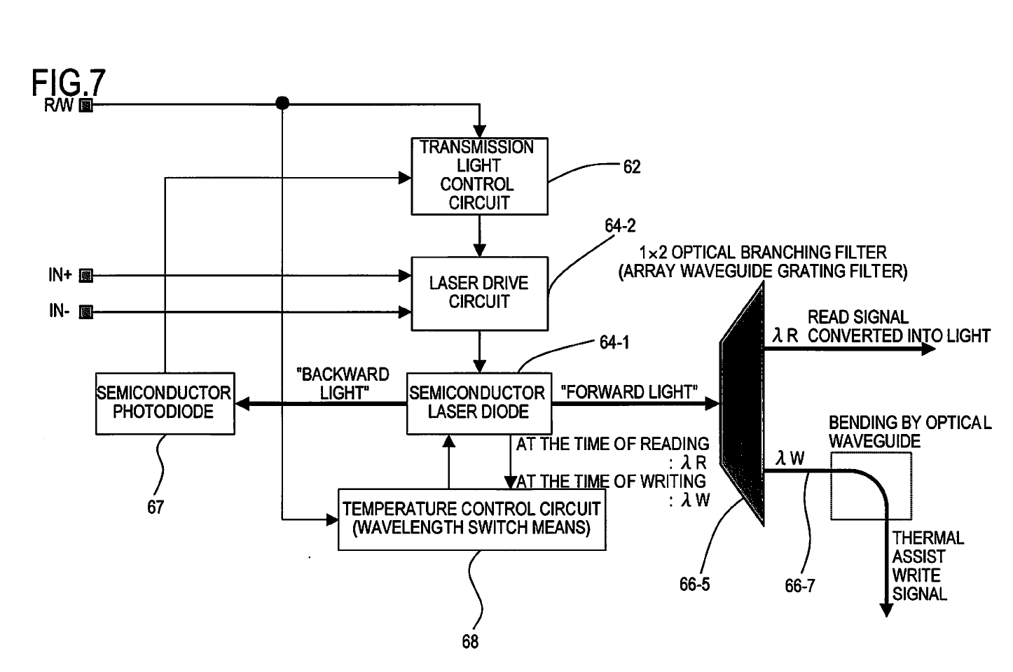

Next, the mounting of the read/write common unit will be described. FIG. 8 is a mounting diagram of the read/write common unit according to a first embodiment of the present invention. In FIG. 8, the same parts as illustrated in FIGS. 1 through 7 are shown by the same symbols.

In FIG. 8, as described in FIG. 1, the interface mechanism of each head-disk section of the magnetic disk device is separated into fixed section (VCM) 51, the actuator arm section (movable section) 52, the suspension section 53 and the slider 2. In the conventional device, the read/write magnetic head is built in the slider 2, and the preamplifier for reading and the drive circuit for the write head are mounted on the fixed section 51. Also, signal lines between the circuit and the head are provided on the arm section 52 and the suspension section 53.

In the above embodiment, on the fixed section 51 on which the read preamplifier 32 and the write head drive circuit 30 are mounted, there are also mounted optical elements such as the semiconductor laser diode 64-1 and the light switch 66-4, and the drive circuit 64-2 for the semiconductor laser diode, and drive signal selector circuit 34.

In the above embodiment, necessary functions are mounted on the fixed section to the possible extent, because it is not preferable to mount circuit elements on the movable portion (arm, suspension and slider) from the viewpoint of weight and generated heat, and because the movable portion including the slider tends to be miniaturized. By this, a lightweight and miniaturized movable portion can be obtained.

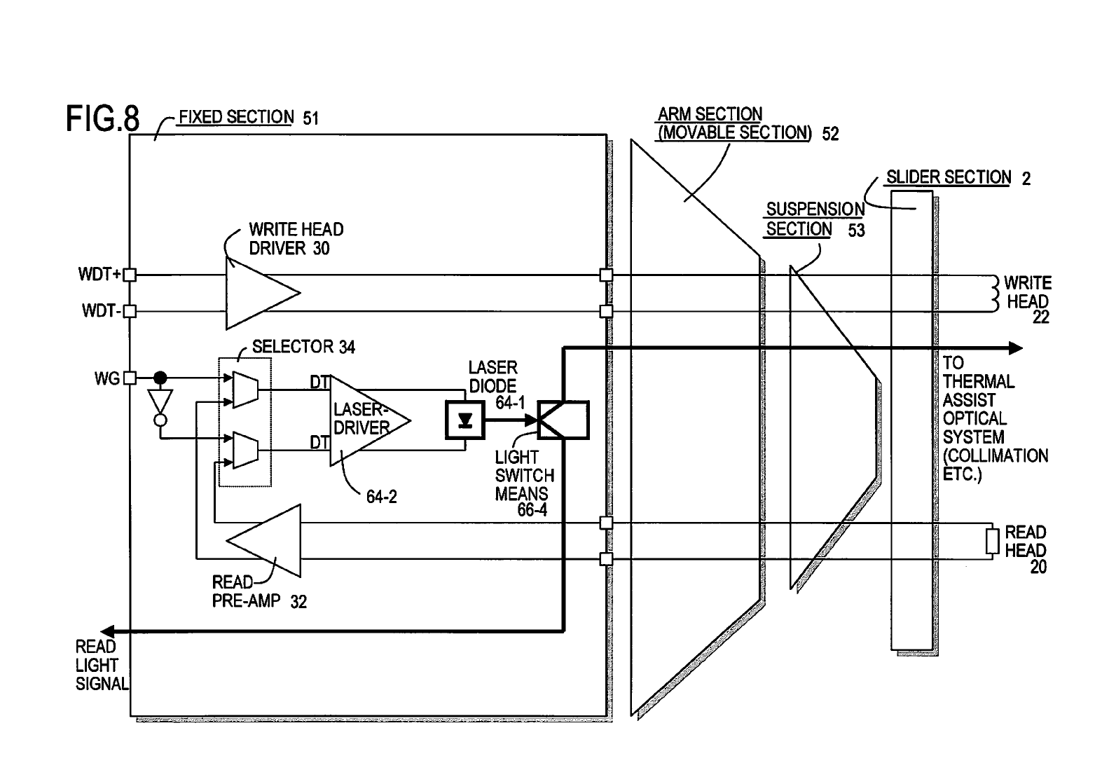

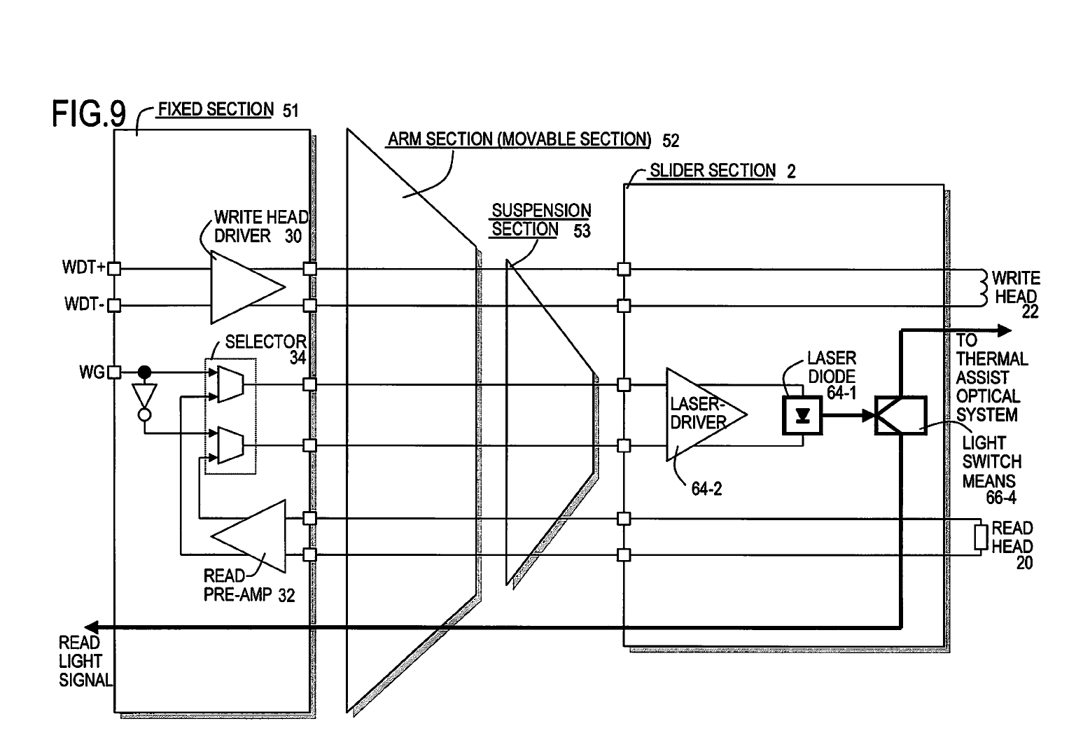

FIG. 9 is a mounting diagram of the read/write common unit according to a second embodiment of the present invention. In FIG. 9, the same parts as illustrated in FIGS. 1 through 8 are shown by the same symbols.

As shown in FIG. 9, according to the present embodiment, common light source (semiconductor laser diode LD) 64-1, LD drive circuit 64-2 for driving the LD 64-1, light switch 64-4, etc. are integrated on the slider 2. On the other hand, the drive signal selector circuit 34, the read preamplifier 32 and the write head drive circuit 30 are mounted on the fixed section 51.

According to the present embodiment, it is configured to collectively dispose only optical elements 64-1, 64-4 at positions as close as possible to heads 20, 22. Thus, the distance to the medium can be shortened, and a merit of a small optical loss is obtained.

FIG. 10 is a mounting diagram of the read/write common unit according to a third embodiment of the present invention. In FIG. 10, the same parts as illustrated in FIGS. 1 through 9 are shown by the same symbols.

As indicated by FIG. 10, the optical elements such as the semiconductor laser diode 64-1 and the light switch 66-4, and the drive circuit 64-2 for the semiconductor laser diode, the drive signal selector circuit 34, the read preamplifier 32 and the write head drive circuit 30 are mounted on the slider 2.

In short, the entire functions are aggregated on the slider section 2. According to the present embodiment, because the number of signal wiring lines in the arm section 52 can be reduced, it is effective to reduce an assembly work etc. of the interface.

Further, it may be possible to adopt a variety of mounting methods, such as mounting a portion of functions on the arm section 52 and the suspension section 53.

[Details of the Read/Write Common Unit]

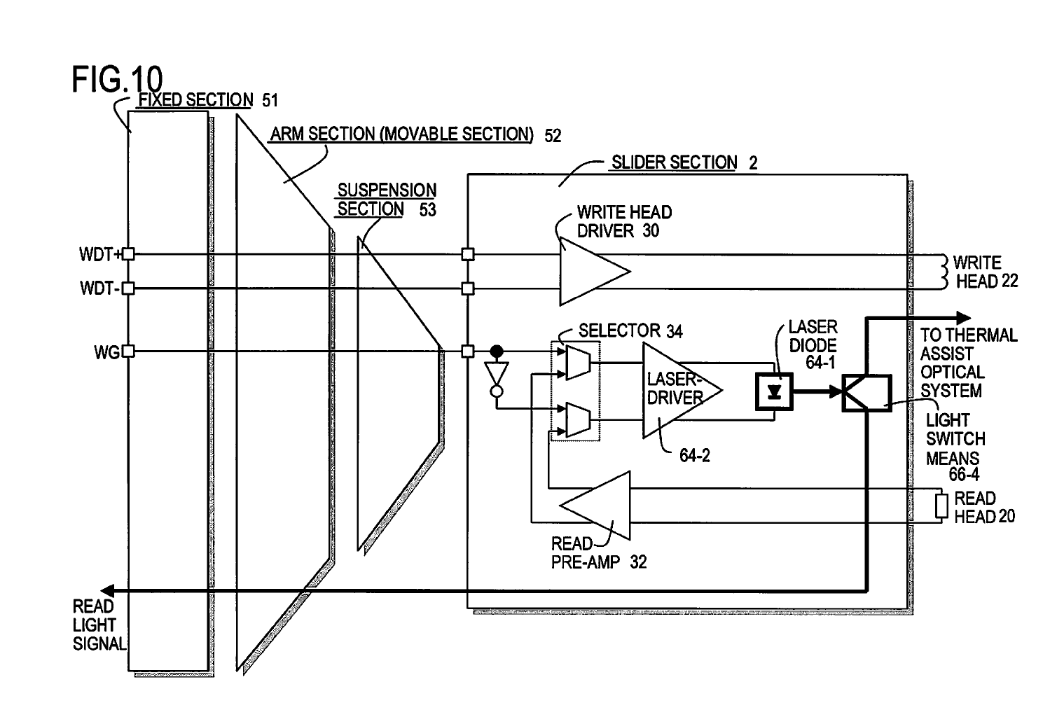

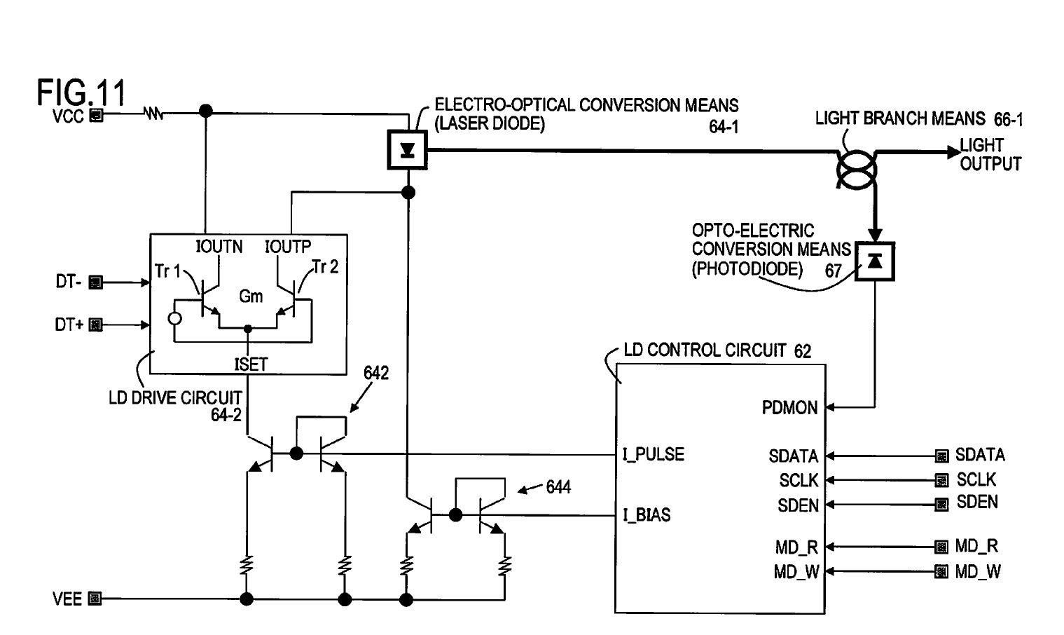

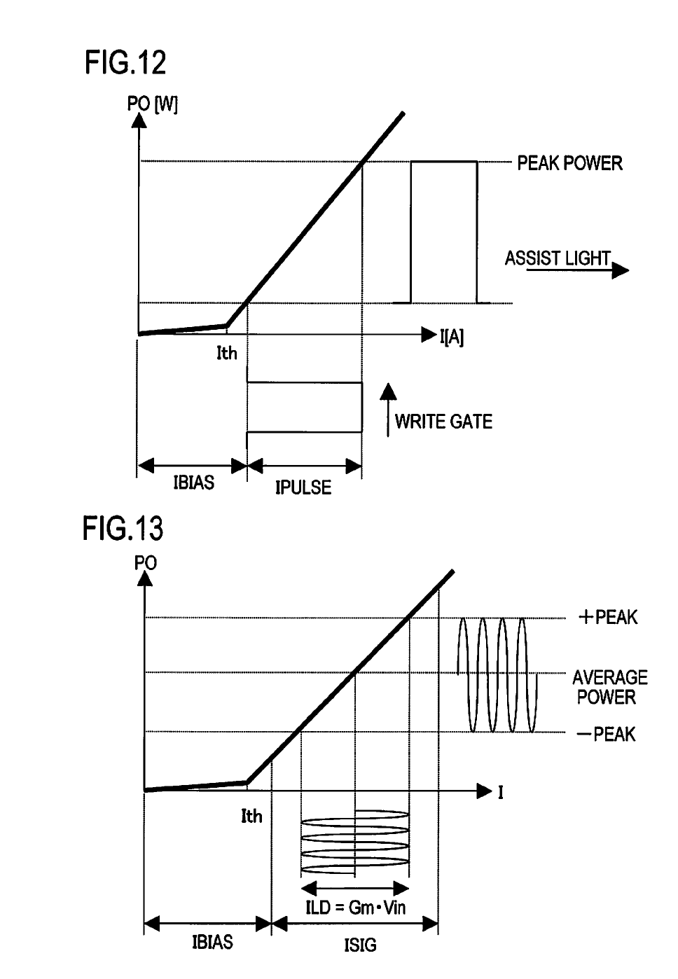

Next, a thermal assist characteristic at the time of writing and a light modulation characteristic at the time of read light transmission will be described. FIG. 11 is a configuration diagram of the read/write common unit shown in FIGS. 2 through 8. FIG. 12 is an explanation diagram of LD modulation operation for a thermal assist light at the time of writing, in the configuration shown in FIG. 11. Also, FIG. 13 is an explanation diagram of the LD modulation operation of a read signal at the time of reading, in the configuration shown in FIG. 11.

As shown in FIG. 11, a light output power control loop is constituted of the LD drive circuit 64-2, the electro-optical conversion means (laser diode) 64-1, the light branch section 66-1, the optical-electric converter (photodiode) 67 and the LD (light emission) control circuit 62.

In the figure, a signal DT+/DT− is an input electric signal to the LD drive circuit 64-2, and is input either a write data at the time of writing or a read data at the time of reading. According to the positive/negative direction of the DT+/DT− signal and the magnitude thereof, the output current at an IOUTP terminal of the LD drive circuit 64-2 is modulated, so as to drive the laser diode (LD) 64-1.

Signals SDATA, SCLK and SDEN to be input to the LD control circuit 62 are three-wire serial signals. The signals SDATA, SCLK and SDEN give the light power control target values at the time of reading and at the time of writing and information for setting a ratio of I_PULSE (I_SIG) to I_BIAS in an LD supply current to the LD control circuit 62.

Also, a mode signal MD_R, MD_W is a signal for selecting each operation state of the read mode and the write mode, respectively, and is input to the LD control circuit 62.

A bias current source 644 is connected to the laser diode 64-1. A bias current corresponding to a bias current instruction value I_BIAS, which will be described later, fed from the LD control circuit 62 is made to flow into the laser diode 64-1.

Further, a signal current source 642 is connected to the LD drive circuit 64-2. A current corresponding to a write current instruction value I_PULSE, which will be described later or a read current instruction value I_SIG, fed from the LD control circuit 62, is made to flow into LD drive circuit 64-2.

The LD drive circuit 64-2 is constituted of a pair of differential transistors Tr1, Tr2 to be driven by the input signal DT+/DT−. The collector of one transistor Tr1 is connected to a reference power source VCC (IOUTN), and the collector of the other transistor Tr2 is connected to the laser diode 64-1 (IOUTP). The emitters of both transistors Tr1, Tr2 are connected to the signal current source 642.

Using FIG. 12, the LD modulation operation for write thermal assist light will be explained.

A write gate signal being input to the LD drive circuit 64-2 at the time of writing is normally a digital signal having “1” or “0”. For example, when the write gate signal is “1”, a write data is written. In the thermal assist recording, the difference of the above “1” and “0” may be made correspondent to ON/OFF of the light. By irradiating light only to the spots of magnetic disk 3 on which magnetization is to be reversed, so as to rise to the Curie temperature, easy writing is enabled.

For the above purpose, a light modulation method for the thermal assist at the time of writing is a pulse intensity modulation method. Namely, the drive current of the laser diode 64-1 is switched ON or OFF according to “1” or “0” of the write gate signal.

Further, as indicated by FIG. 12, a characteristic of a current I versus light output P of the laser diode 64-1 has a certain current threshold Ith. Approximately at the point of exceeding the above current threshold, a light output power substantially in proportion to the drive current can be obtained. Accordingly, when the drive current at the time of OFF is completely made zero, a period from the time of zero drive current I until a time to reach the current threshold Ith becomes a light emission delay time, when the signal speed is high. As a result, the pulse width of the light output signal relative to the electric signal becomes narrow.

To solve the above problem, the current value at the time of “OFF” is set to a value nearly exceeding the threshold Ith. Namely, a direct current (DC) offset current (I_BIAS) is continuously supplied from the bias current source 644. Then, a pulse current (I_PULSE) corresponding to the signal “1” or “0” is supplied from the LD drive circuit 64-2. Here, in case of a relatively low operation speed in which light emission delay does not cause a problem, the offset current is not always necessary.

As such, in the thermal assist at the time of writing, it is necessary to consider power for irradiation at the time of the magnetization reversal. Therefore, desirably, the control target (I_PULSE) of the write assist light is set to be a peak value of the pulse.

Next, referring to FIG. 13, the LD modulation operation in case of converting the read signal into an optical signal will be described. In regard to a read signal, when a horizontal recording system is applied, the change point of magnetization becomes the peak position of the read electric signal. Therefore, to prevent the peak position from being collapsed, linear operation is required in the circuits of a read system. For the above reason, a linear (analog) modulation method is to be applied to the light modulation method. However, when a vertical recording system is applied, the above method is not always necessary because the change point of magnetization becomes the edge position of a read signal, and accordingly, an operation becomes close to a digital signal operation.

For the above purpose, at the time of reading, a signal current in proportion to the magnitude of an input read data is supplied from the LD drive circuit 64-2, using the linear region of the laser diode 64-1. For example, as indicated by FIG. 13, a DC offset current (I_BIAS) is continuously supplied from the bias current source 644 so that the linear region of the laser diode 64-1 is used even at the time of a negative peak value (−Peak) of the read data.

The LD drive circuit 64-2 superposes therewith a signal current (I_SIG) according to the read data input from the input DT+/DT−. Assuming Gm to be a differential transfer conductance (=voltage−current conversion gain) of the LD drive circuit 64-2, and Vin to be a differential input signal, then, an LD supply current is (I_BIAS+I_SIG/2)Gm*Vin/2.

As the power control of the read signal light, a method for making an average value of the light output to be a certain control target I_SIG is the simplest. For example, because the preamble area of the read data is repetitive signals, it is desirable that the LD control circuit 62 sets a read current instruction value I_SIG of the signal current source 642, by a control method such that the average power in the above preamble area becomes constant.

Desirably, the LD drive circuit 64-2 is configured of a linear differential amplifier circuit using bipolar transistors. With this, the transfer conductance (Gm) can easily be adjusted by an emitter size ratio.

[LD Control Circuit]

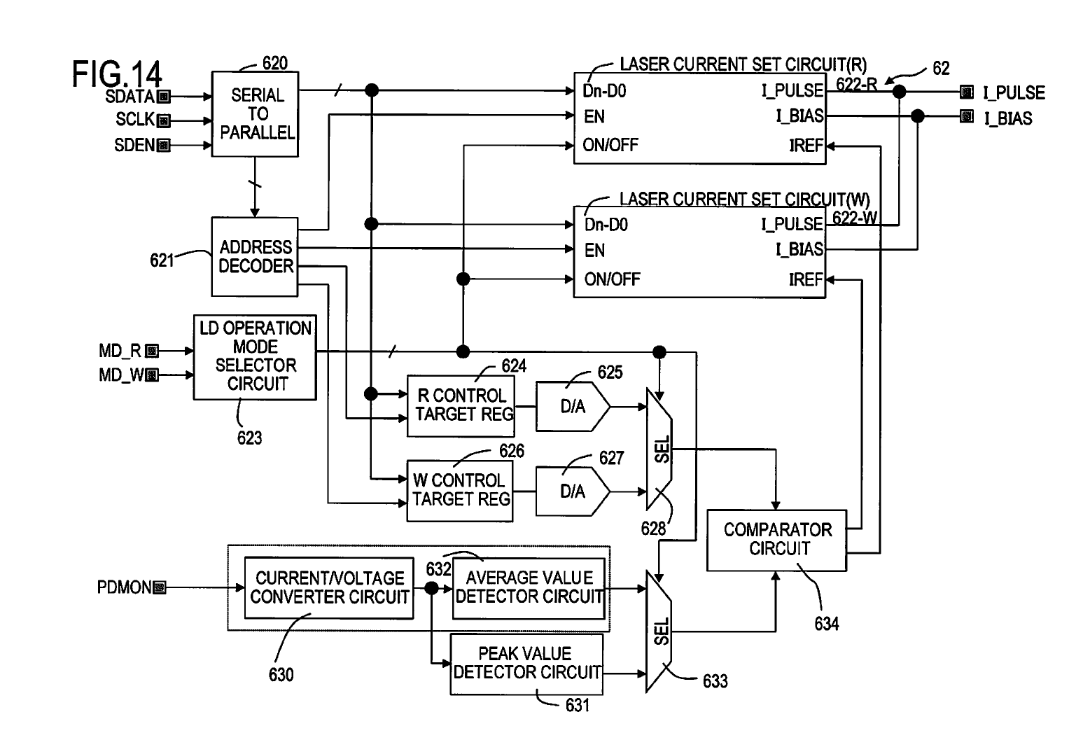

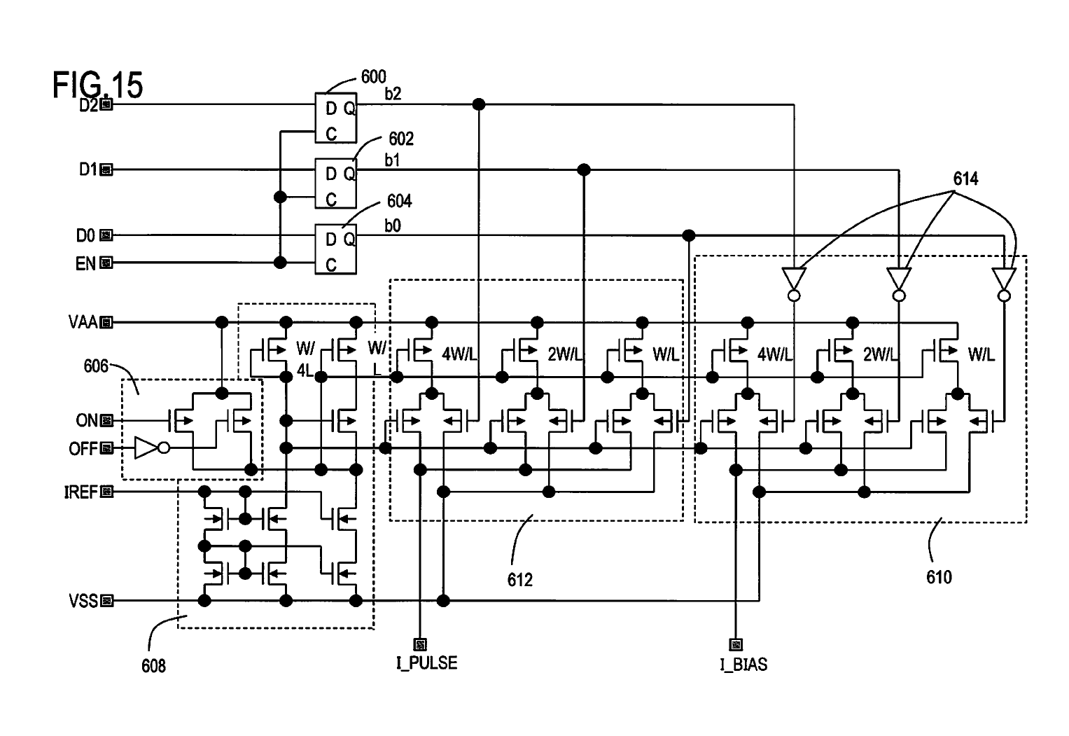

FIG. 14 is a block diagram of LD control circuit 62 shown in FIG. 11, FIG. 15 is a circuit diagram of a laser current set circuit shown in FIG. 14.

As indicated by FIG. 14, as a drive function, the LD control circuit 62 includes an LD current set circuit 622-R at the time of reading, an LD current set circuit 622-W at the time of writing, a register 624 for a light power control target value at the time of reading and a D/A converter circuit 625 therefor, a register 626 for a light power control target value at the time of writing and a D/A converter circuit 627 therefor, and a switch circuit 628 for selecting either of the both control target values.

Further, as a function for monitoring light output, the LD control circuit 62 includes a current/voltage converter circuit 630, an average value detector circuit 632, a peak value detector circuit 631 and a switch circuit 633 for selecting either of the both detected values.

Each LD current set circuit 622-R, 622-W sets a total value of the signal current (I_PULSE) and a DC offset current (I_BIAS), and the ratio of the both currents.

By the logic between a read operation selection signal (MD_R) and a write operation selection signal (MD_W), an LD mode selector circuit 623 switches LD current set circuits 622-R, 622-W, control target switch circuit (selector) 628, and light power detection value selector circuit (selector) 633.

Also, as explained in FIG. 11, current ratio set information and a control target value are set via a three-wire serial interface. Here, a serial/parallel converter circuit 620 receives the current ratio set information and the control target value through the three-wire serial interface, and separates into a data and an address. Then, the serial/parallel converter circuit 620 sends address information to an address decoder 621. The address decoder 621 selects a circuit block (LD current set circuits 622-R, 622-Wand control target registers 624, 626) of a write object, and writes a set data into the selected circuit.

Further, in each read/write operation mode, a comparator circuit 634 compares each control target value with either of the average value and the peak value of a light output power signal (PDMON) monitored by the monitor element 67. The comparator circuit 634 transmits a control signal (IREF) according to the comparison result, to the LD current set circuits 622-R, 622-W.

Here, as described earlier, at the time of outputting a read light signal, the comparator circuit 634 compares an average monitor signal value from the average value detector circuit 632 with the read control target value in the read control target register 624. Also, at the time of write thermal assist, the comparator circuit 634 compares a peak monitor signal value from the peak value detector circuit 631 with the write control target value in the write control target register 626. Thus, LD currents (I_PULSE, I_BIAS) of the LD current set circuits 622-R, 622-W are automatically adjusted so that the light output power becomes each target value.

Using FIG. 15, the LD current set circuits 622-R, 622-W will be explained further. FIG. 15 is an exemplary transistor circuit configuration of an LD current set circuit in the LD control circuit 62. The circuit shown in FIG. 15 is configured of a P-channel MOS D/A (digital/analog) converter circuit of source current type, in which a 3-bit configuration is shown for sample explanation.

In FIG. 15, signals D2-D0 are parallel digital data for setting the current ratio of I_PULSE/I_BIAS. The signals D2-D0 are written into internal registers 600, 602 and 604 triggered by an EN (enable) signal. Since the laser diode LD has a varied threshold current value depending on an environmental temperature and an individual type, the ratio of a drive current I_PULSE to I_BIAS to obtain the same light output power becomes different. Therefore, a function for adjusting the current ratio becomes necessary.

The DA converter circuit includes a first DA converter circuit 612 for the-drive current I_PULSE and a second DA converter circuit 610 for the bias current I_BIAS. Each DA converter circuit 612, 610 is configured of a MOS transistor group to which binary-weighted current sources (4W/L, 2W/L, W/L) are connected in parallel.

Further, using each bit value of the signals D2-D0, each DA converter circuit 612, 610 performs D/A conversion by switching ON/OFF each current source being weighted corresponding to each bit.

According to the control signal IREF from the comparator circuit 634 indicated in FIG. 14, the current control circuit 608 supplies to the DA converter circuits 612, 610 a current according to the monitor light. An on/off control circuit 606 controls the operation of the DA converter circuits 612, 610 to be ON/OFF, using an ON/OFF signal from the LD operation mode selector circuit 623.

As to the method of supplying the above current ratio, the relationship of complements is used in the present embodiment. Namely, the drive current I_PULSE and the bias current I_BIAS mutually have the relationship of complements, and are given by the following expression (1).

$$\frac{{I}_{BIAS}}{{I}_{PULSE}} = \frac{( {2}^{N} - 1 ) - {\sum }_{k = 0}^{N - 1} {b}_{k} \cdot {2}^{k}}{{\sum }_{k = 0}^{N - 1} {b}_{k} \cdot {2}^{k}} \qquad ( 1 )$$

Because N=3 according to the present embodiment, the method of supplying the current ratio will be explained using the above example. For example, when the drive current I_PULSE:I_BIAS is desired to be 5:2, because the drive current I_PULSE=5, the set values of the three bits are (b2,b1,b0)=(1,0,1).

Because the complements of the above values are (0,1,0), the value of the bias current I_BIAS becomes 2 (=7−5) in a decimal number. Similarly, it is possible to set the current ratio to be 6:1, 4:3 and the like. For the above purpose, the D/A converter circuit 610 for the bias current has inverting circuits 614 being inserted in an input stage to invert the input bits of three-bit registers 600, 602, 604.

Further, by making the resolution N larger, a finer ratio is settable, needless to say. The above current ratio is made to correspond to a variety of forms of a current-light output characteristic provided in the laser diode.

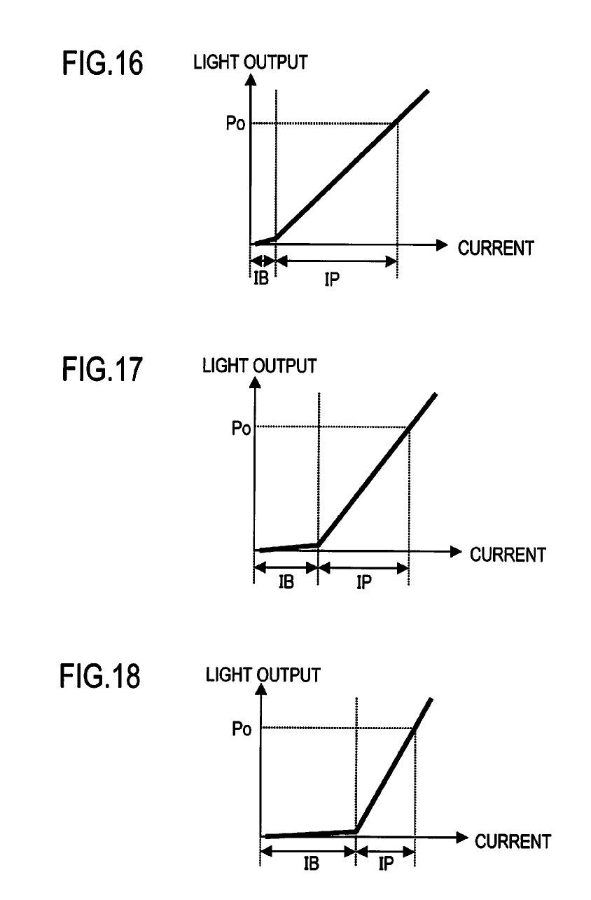

FIGS. 16 through 18 show three typical forms of the current-light output characteristic of the laser diode. FIG. 16 shows a case that the current threshold IB (Ith) is relatively small, and the inclination of the light output relative to the current is relatively small. FIG. 17 shows a case of having a moderate current threshold value IB and a moderate inclination characteristic. Also, FIG. 18 shows a case of having a relatively large current threshold value IB, and the inclination of the light output relative to the current is relatively sharp.

With regard to the current ratio, when it is desired to obtain a predetermined light output PO, in the case of a laser diode having such a characteristic as shown in FIG. 16, the bias current is small and the ratio of the pulse (drive) current thereto is large. In the case of a laser diode having such a characteristic as shown in FIG. 18, reversely, the bias current becomes large, and the ratio of the pulse (drive) current thereto is required to be small.

Because the characteristics of the laser diodes have individual differences, and also vary with environments such as temperature, the output ratio is set to flexibly cope with such characteristic variation.

Further, in FIG. 15, the control signal IREF is adjusted by the comparison result of the control target value of the light output power with the monitor value. The current control circuit 606 scales a current absolute value while maintaining the aforementioned current ratio. Assuming Ki be a current amplification factor inside the present circuit, then the relationship shown in the following expression (2) holds.

I_{PULSE}+I_{BIAS}=Kᵢ·I_{REF} (2)

Further, in FIG. 15, an ON terminal of on/off control circuit 606 is set “high” when the current set circuit is to be selected, and thereby current is output. For example, in case of a read mode, the ON terminal of current set circuit 622-R for reading is set “high”. Similarly, an OFF terminal is set “high” when the current set circuit is not to be selected. Additionally, when the both are “high” or “flow”, the current set circuit is not selected.

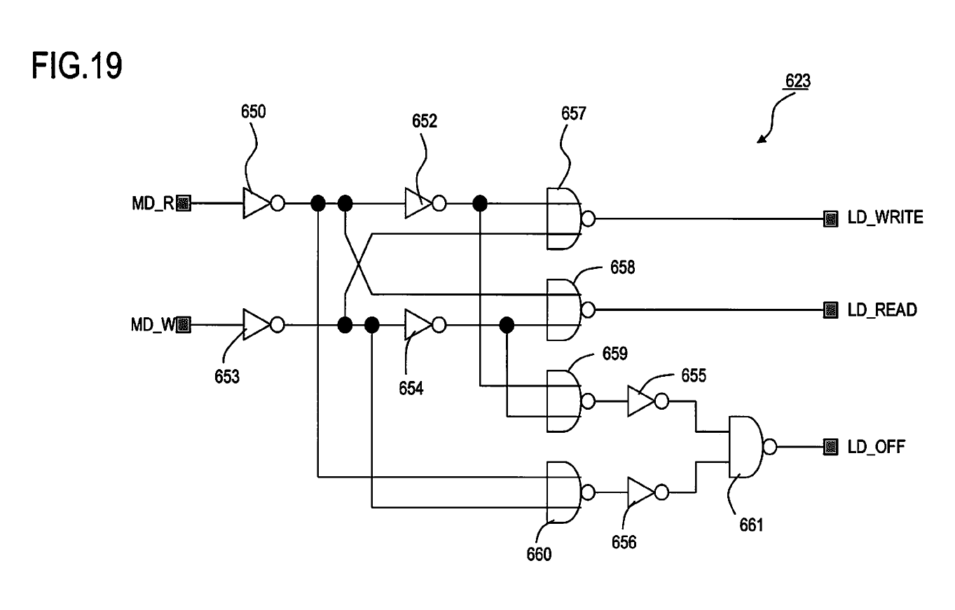

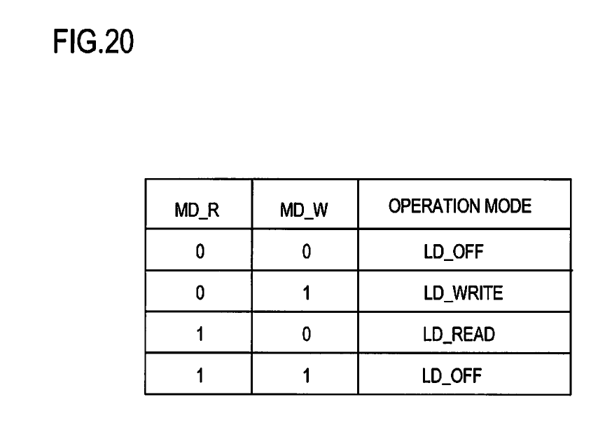

FIG. 19 is a logic circuit diagram of the LD operation mode selector circuit shown in FIG. 14, and FIG. 20 is an explanation diagram of an input signal and the operation mode thereof. In FIG. 19, symbols 650-656 are signal inverting circuits, 657-660 are inverted-output type OR circuits, and 661 is an inverted-output type AND circuit.

Using the logic configuration shown in FIG. 19, according to the logic of the read operation selection signal (MD_R) and the write operation selection signal (MD_W), LD_WRITE (write mode: setting laser diode output power/current for thermal assist recording), LD_READ (read mode: setting laser diode output power/current for read data light output) and LD_OFF (laser drive to be OFF) are output, as shown in FIG. 20.

### Other Embodiments

According to the above-mentioned embodiments, the light source is explained using the semiconductor laser diode. However, it may be possible to apply other light sources. Further, the present invention is also applicable to a device having two or more disks mounted thereon. Similarly, the magnetic recording medium is not limited to a disk shape, and media of other forms may also be applicable.

Because the light source for thermal-assist recording is also used as the light source for read light transmission at the time of reading, high density recording compatible with high speed transfer can be achieved at low cost in a small size. Also, because of separate driving between at the time of reading and at the time of writing, the characteristic for the thermal assist light and for the optical communication light can be set optimally.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. A thermal-assist magnetic recording device for reading data from a magnetic recording medium and writing data on the magnetic recording medium while applying heat, comprising:
a read element that reads the data from the magnetic recording medium;
a write element that writes data on the magnetic recording medium;
a light transmission unit;
a signal selector circuit that selects a read signal from the read element at the time of reading by the read element, selects a write signal to the write element at the time of writing by the write element, and drives the light transmission unit by the selected signal; and
an output light selection unit that outputs an output light from the light transmission unit, as either an optical signal at the time of reading or a thermal assist light for applying the heat at the time of writing.

2. The thermal-assist magnetic recording device according to claim 1, further comprising:
a light signal control unit that controls a light output characteristic of the light transmission unit to be different light output characteristics at the time of reading from light output characteristics at the time of writing.

3. The thermal-assist magnetic recording device according to claim 1, further comprising:
a slider that is mounted the read element and the write element; and
a fixed unit that is mounted the light transmission unit, the signal selector circuit and the output light selection unit.

4. The thermal-assist magnetic recording device according to claim 1, further comprising:
a slider that is mounted at least the read element, the write element, the light transmission unit and the output light selection unit.

5. The thermal-assist magnetic recording device according to claim 1,
wherein the output light selection unit is constituted of a light switch that switches output destinations according to a read instruction and a write instruction.

6. The thermal-assist magnetic recording device according to claim 1, the light transmission unit further comprising:
an electro-optical conversion element; and
a drive circuit that drives the electro-optical conversion element.

7. The thermal-assist magnetic recording device according to claim 2, the light signal control unit further comprising:
a monitor element that monitors the output light from the light transmission unit; and
a control circuit that compares an output of the monitor element with either a control target value at the time of reading or a control target value at the time of writing, and according to the comparison result, controls light output power of the light transmission unit.

8. The thermal-assist magnetic recording device according to claim 7, the light transmission unit further comprising:
an electro-optical conversion element; and
a drive circuit that current-drives the electro-optical conversion element,
wherein the control circuit controls a current value of the drive circuit.

9. The thermal-assist magnetic recording device according to claim 8, the control circuit further comprising:
an average value detector circuit that detects an average value of the monitor element output:
a peak value detector circuit that detects a peak value of the monitor element output;
a comparison circuit that compares an output value of the average value detector circuit with the control target value at the time of reading, while at the time of writing, compares an output value of the peak value detector circuit with the control target value at the time of writing; and
a current control circuit that controls a current value of the drive circuit by the comparison circuit output.

10. The thermal-assist magnetic recording device according to claim 8, the drive circuit further comprising:
a bias current source that supplies a bias current to the electro-optical conversion element; and
a drive current circuit that flows a drive current to the electro-optical conversion element according to the read signal or the write signal,
wherein, according to a ratio of each bias current value and the drive current value, instructed at the time of reading and at the time of writing, the control circuit controls the current value of the bias current source and the current value of the drive current circuit.

11. The thermal-assist magnetic recording device according to claim 10, the control circuit further comprising:
a read current set circuit that controls the current value of the bias current source and the current value of the drive current circuit, according to the ratio of the bias current value and the drive current value instructed at the time of reading; and
a write current set circuit that controls the current value of the bias current source and the current value of the drive current circuit according to the ratio of the bias current value and the drive current value, instructed at the time of writing.

12. The thermal-assist magnetic recording device according to claim 10, the control circuit further comprising:
a resistor that is set the drive current value;
a first digital/analog converter circuit that digital-to-analog converts the drive current value in the register, and outputs a control current of the drive current circuit; and
a second digital/analog converter circuit that digital-to-analog converts an inverted value of the drive current value in the register, and outputs a control current of the bias current source.

13. A magnetic storage device comprising:
a magnetic recording medium;
a read element that reads the data from the magnetic recording medium;
a write element that writes data on the magnetic recording medium;
a light transmission unit;
a signal selector circuit that selects a read signal from the read element at the time of reading by the read element, selects a write signal to the write element at the time of writing by the write element, and drives the light transmission unit by the selected signal; and
an output light selection unit that outputs an output light from the light transmission unit, as either an optical signal at the time of reading or a thermal assist light for applying the heat at the time of writing.

14. The magnetic storage device according to claim 13, further comprising:
a light signal control unit that controls a light output characteristic of the light transmission unit to be different light output characteristics at the time of reading from light output characteristics at the time of writing.

15. The magnetic storage device according to claim 13, further comprising:
a slider that is mounted the read element and the write element;
a fixed unit that is mounted the light transmission unit, the signal selector circuit and the output light selection unit; and
a connection unit that electrically connects between the fixed unit and the slider.

16. The magnetic storage device according to claim 13, further comprising:
a slider that is mounted at least the read element, the write element, the light transmission unit and the output light selection unit; and
an actuator that positions the slider at a desired position of the magnetic recording medium.

17. The magnetic storage device according to claim 13, wherein the output light selection unit is constituted of a light switch that switches output destinations according to a read instruction and a write instruction.

18. The magnetic storage device according to claim 13, the light transmission unit further comprising:
an electro-optical conversion element; and
a drive circuit that drives the electro-optical conversion element.

19. The magnetic storage device according to claim 14, the light signal control unit further comprising:
a monitor element that monitors the output light from the light transmission unit; and
a control circuit that compares an output of the monitor element with either a control target value at the time of reading or a control target value at the time of writing, and controls light output power of the light transmission unit according to the comparison result.

20. The magnetic storage device according to claim 19, the light transmission unit further comprising:
an electro-optical conversion element; and
a drive circuit that current-drives the electro-optical conversion element,
wherein the control circuit controls a current value of the drive circuit.
